(19) United States
(12) Patent Application Publication
(10) Pub. No.: US 2015/0288973 A1
(43) Pub. Date: Oct. 8, 2015

(54) METHOD AND DEVICE FOR SEARCHING FOR IMAGE

(71) Applicant: INTELLECTUAL DISCOVERY CO., LTD., Seoul (KR)

(72) Inventors: Ho Dong Lee, Bucheon-si (KR); Soon Gi Hong, Seoul (KR); Yoon Sik Choe, Goyang-si (KR)

(73) Assignee: INTELLECTUAL DISCOVERY CO., LTD., Seoul (KR)

(21) Appl. No.: 14/413,088

(22) PCT Filed: Jul. 4, 2013
(86) PCT No.: PCT/KR2013/005950

§ 371 Date: Jan. 6, 2015

(30) Foreign Application Priority Data
Jul. 6, 2012 (KR) 10-2012-0073941

(51) Int. Cl. H04N 19/176; H04N 19/14; G06F 17/30; H04N 19/122; H04N 13/00; H04N 19/70; H04N 19/137

(52) U.S. Cl. CPC H04N 19/176; H04N 19/70; H04N 19/14; H04N 19/137; H04N 19/122; H04N 13/0022; G06F 17/30247; H04N 2213/003

(57) ABSTRACT

Disclosed is a new method of searching for an image at a high speed based on only coding unit depth information of high efficiency video coding (HEVC), which is a next-generation image coding codec. Unlike an existing method of dividing a frame into 16 sub-images and sub-dividing the sub-images into fixed image-blocks to perform calculation, the method of searching for an image according to the present invention uses a block having a 64×64 size, which is the largest coding unit (LCU) used in the HEVC coding codec itself, as it is. Furthermore, the method of searching for an image according to the present invention performs an image search based on information on a depth to which the LCU is divided, unlike an existing method of classifying image-block units into five kinds of edges to calculate a histogram and using the histogram as a basis for an image search.

### TECHNICAL FIELD

The present invention relates to a method and apparatus for searching for an image, and more particularly, to a method and apparatus for searching for an image which make it possible to improve a search speed by using grammatical information of video data such as an image.

### BACKGROUND ART

In order to efficiently provide N-screen, high integration of multimedia using a cloud system is necessary. However, the high integration of multimedia causes a problem of making it difficult to manage multimedia and search for an image in the cloud system.

Therefore, a cloud system in which multimedia is highly integrated is in need of a high-speed image search algorithm for classifying images for multimedia management and rapidly searching for an image desired by a user.

To this end, a technique of extracting a video key frame using an edge histogram has hitherto been used. As one method for indexing and searching for video information, this technique uses an edge histogram which is insensitive to a change of an image and represents the spatial distribution of edges (portions of the image in which brightness drastically changes).

With reference to FIG. 1, an image search technique according to related art will be described. FIG. 1 illustrates an example of an image technique according to related art. As shown in FIG. 1, in a technique of searching for an image using an edge histogram according to related art, one image frame is divided into 16 sub-images that do not overlap, and one sub-image is defined in units of divided areas referred to as image-blocks.

The image-blocks are subdivided into four sub-blocks, and an edge is detected from each sub-block according to a method of filtering an average grey level. Detected edges are classified according to five directions, that is, vertical, horizontal, 45° diagonal, 135° diagonal, and non-directional edges, and a histogram on edges is generated according to the respective sub-images. Since one image frame consists of 16 sub-images as mentioned above, 80 (=16×5) pieces of edge information are generated from each image frame and assigned to 80 bin memories. According to related art, five 4-tap filters filter the respective sub-images to calculate an edge size, and it is determined that a specific edge is included when it is determined that the edge size is equal to or larger than a specific threshold.

### DISCLOSURE

### Technical Problem

The present invention is directed to providing a method of performing an image search using coding unit depth data generated in an encoding process of a high efficiency video coding (HEVC) encoder, and an apparatus using the method.

The objective of the present invention is not limited to that mentioned above, and other objectives that have not been mentioned above may also be clearly understood by those of ordinary skill in the art from descriptions below.

### Technical Solution

An image search method for achieving the aforementioned objective of the present invention uses coding unit depth data generated in an encoding process of a high efficiency video coding (HEVC) encoder (hereinafter, referred to as coding unit depth information).

A method of searching for a image according to an embodiment of the present invention includes generating a first histogram on coding unit depth information of a key frame which is a search objective, generating a second histogram on coding unit depth information of a frame from a video which is a search target, generating difference information between the first histogram and the second histogram, and detecting a frame corresponding to the key frame based on the difference information.

The generating of the first and second histograms may include generating the histograms using coding unit depth information extracted according to largest coding units (LCUs) in HEVC.

In an embodiment, the generating of the first and second histograms may include extracting the coding unit depth information indicating a result of dividing LCUs which are basic units of an encoding target through an encoding process of an HEVC encoder, extracting maximum coding unit depth histograms in the LCUs, and calculating coding unit depth histogram difference information.

Coding unit depths of the LCUs are information including the complexity or the degrees of movement of corresponding areas. The HEVC encoder divides a complex area in the image or an area in which a dynamic movement occurs into smaller sub-coding units.

When the HEVC encoder encodes a coding unit, the HEVC encoder selects the coding unit depth of a case of the lowest rate-distortion (RD) cost and performs encoding after encoding all the possible cases of coding unit depths. Therefore, a coding unit depth can be used as reliable information representing the complexity characteristic of the corresponding LCU. In order to achieve the above objective, the maximum of coding unit depths of an LCU is used as the information. A coding unit depth of 0 means that the LCU having a 64×64 size has not been divided, and a maximum coding unit depth of 1 means that the LCU has been divided into 32×32 sizes. A coding unit depth of 2 means that the LCU has been divided into 16×16 sizes, and a coding unit depth of 3 means that the LCU has been divided into 8×8 sizes.

The present invention performs a method of obtaining a histogram in a frame using the maximum coding unit depth in an LCU as information. In other words, the size of the smallest coding unit in an LCU is obtained and determined as complexity in an LCU area, and a coding unit depth histogram in the whole frame is calculated and used as a histogram of a key frame.

Next, a coding unit depth histogram of a frame to be compared with the key frame to be searched for in a video is extracted, and difference information of the histogram of the key frame is generated. Difference information between coding unit depths, that is, coding unit depth histogram difference (CUDHD), may be expressed by the following equation.

$$CUDHD = {\sum }_{i} \vert {CUDHD}_{key} - {CUDHD}_{currentframe} \vert \vert$$

(CUDHD_{key} is a histogram on coding unit depth information of the key frame which is a search objective, CUDHD_{currentframe} is a histogram on coding unit depth information of the frame which is a comparison target of the key frame, and i is an index representing depth information)

Meanwhile, a method of searching for an image according to an aspect of the present invention may be implemented as a program to be executed in a computer and stored in a computer-readable recording medium.

### Advantageous Effects

As described above, in a method of searching for an image according to the present invention, histogram difference information is generated using coding unit depth data generated through an encoding process by a high efficiency video coding (HEVC) encoder. In other words, since a histogram is generated using coding unit depth information that has already been generated in the encoding process by the HEVC encoder, it is possible to skip a process of generating edge information and a calculation process of a filtering-based edge direction determination operation in related art, so that an image search speed is improved.

In addition, by assigning 0, 1, 2, and 3 to the total number of coding unit depths as indices of a histogram, it is possible to reduce the use of a memory required to store 80 pieces of information according to related art.

### DESCRIPTION OF DRAWINGS

FIG. 1 illustrates an example of an image technique according to related art.

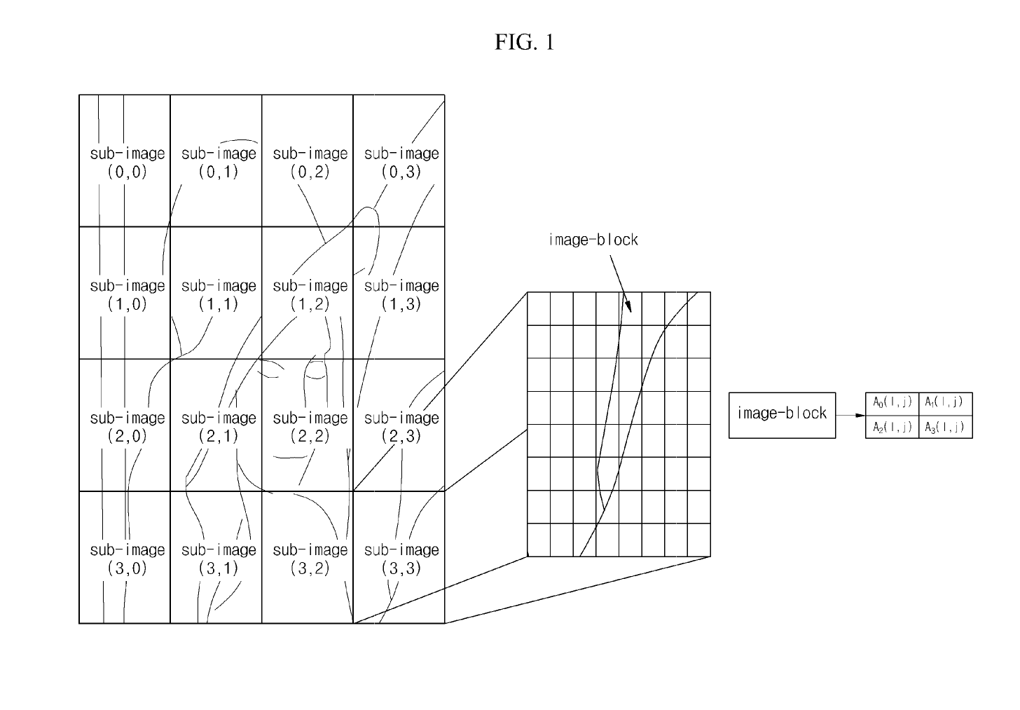

FIG. 2 is a block diagram showing a schematic constitution of an apparatus for searching for an image according to an embodiment of the present invention.

FIG. 3 is a flowchart illustrating a method of searching for an image according to an embodiment of the present invention.

FIG. 4 is an example diagram of coding units used in an encoding process of a high efficiency video coding (HEVC) encoder according to an embodiment of the present invention.

FIG. 5 is an example diagram of a histogram of coding unit depths of one image frame according to an embodiment of the present invention.

### MODES OF THE INVENTION

In the description of the present invention, when detailed descriptions concerning known art related to the present invention are determined to unnecessarily obscure the gist of the present invention, the detailed descriptions will be omitted.

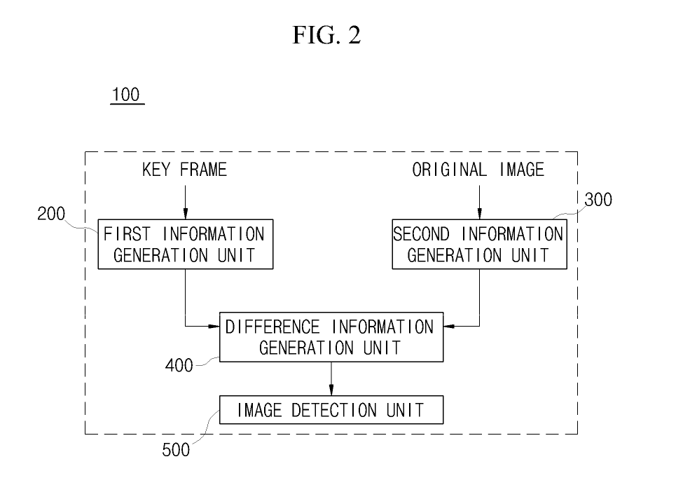

FIG. 2 is a block diagram showing a schematic constitution of an apparatus for searching for an image according to an embodiment of the present invention.

Referring to FIG. 2, an apparatus 100 for searching for an image according to an embodiment of the present invention includes a first information generation unit 200, a second information generation unit 300, a difference information generation unit 400, and an image detection unit 500.

The first information generation unit 200 generates histogram (hereinafter, referred to as first histogram) information of coding unit depth information of a key frame which is a search objective.

A coding unit depth is generated in an encoding process by a high efficiency video coding (HEVC) encoder, and includes information on the complexity or the degree of movement of a specific area in an image frame. The HEVC encoder divides a complex image area or an area having dynamic movement information in one frame into sub-coding units and performs an encoding process.

In other words, in an HEVC encoding process, one image frame consists of a plurality of largest coding units (LCUs), and one LCU may be divided in sub-coding units according to the complexity or the degree of movement of the corresponding unit image. An LCU means the largest coding unit among coding units having various sizes, and generally has a size of 8×8 to 64×64.

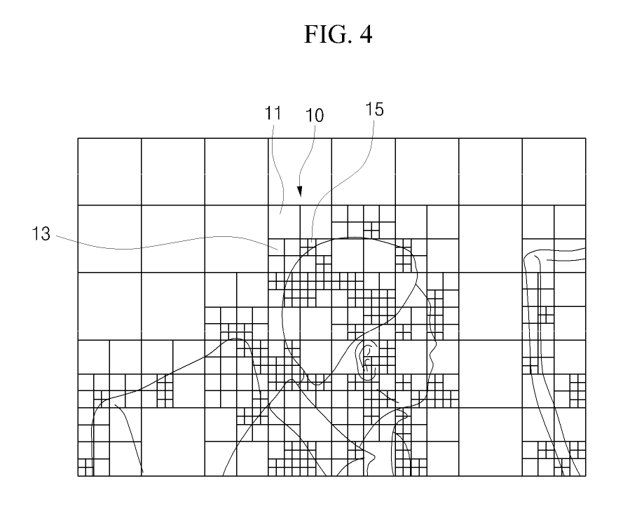

According to an embodiment, a coding unit depth will be described based on an LCU having the 64×64 size. FIG. 4 is an example diagram of coding units used in an encoding process of an HEVC encoder according to an embodiment of the present invention.

As shown in FIG. 4, in HEVC encoding, one image frame may be divided into coding units having various sizes. In FIG. 4, it is possible to see that the one image frame consists of 40 LCUs.

By giving any one LCU 10 among the LCUs of FIG. 4 as an example, a coding unit depth will be described in detail. As mentioned above, the LCU 10 has the 64×64 size, and is quadrisected into first sub-coding units 11 having the 32×32 size. Also, the first sub-coding units 11 having the 32×32 size is quadrisected into second sub-coding units 13 having the 16×16, and the second sub-coding units 13 having the 16×16 size is quadrisected into third sub-coding units 15 having the 8×8 size.

A case in which the coding unit depth of the LCU 10 which is the largest unit is 0 means that the LCU having the 64×64 size has not been divided, and a case in which the coding unit depth is 1 means that the LCU has been quadrisected into first sub-coding units 11 having the 32×32 size.

Also, a case in which the coding unit depth is 2 means that the LCU has been divided into second sub-coding units 13 having the 16×16 size, and a case in which the coding unit depth is 3 means that the LCU has been divided into third sub-coding units 15 having the 8×8 size. Here, the greater the coding unit depth, the greater image complexity or the degree of movement in the corresponding LCU.

A method of searching for an image according to the present invention is characterized by generating a histogram with coding unit depth information extracted according to LCUs in HEVC. More specifically, in the method of searching for an image according to the present invention, histogram information is generated in one frame using information of the maximum coding unit depth in an LCU. In other words, the size of the smallest coding unit in an LCU is obtained and determined as the complexity of the LCU area, and a coding unit depth histogram in the whole frame is generated.

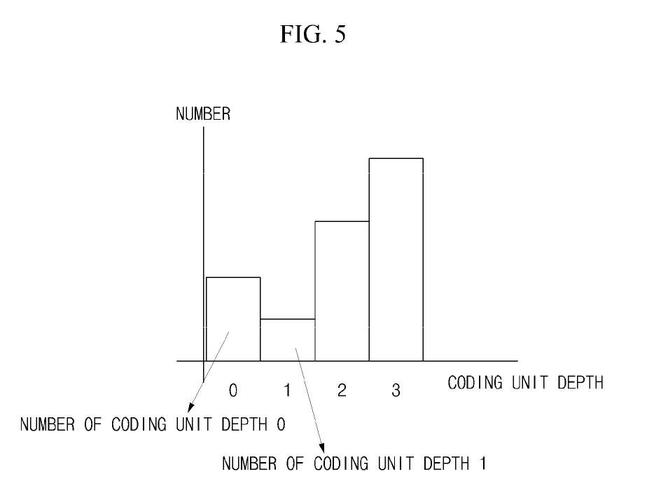

For example, in the image frame (consisting of a total of 40 LCUs) shown in FIG. 4, there are 18 LCUs having a coding unit depth of 0, one LCU having a coding unit depth of 1, no LCUs having a coding unit depth of 2, 21 LCUs having a coding unit depth of 3. Based on such number information of coding unit depths, a histogram is generated from each image frame. An example of a histogram generated through the process as described above is shown in FIG. 5.

The second information generation unit 300 generates a histogram (hereinafter, referred to as a second histogram) of coding unit depth information from a specific image frame of a video which is a search target.

According to an embodiment, the second information generation unit 300 may select an arbitrary frame from the video which is the search target, and also generates a second histogram on coding unit depth information for a frame subsequent to the selected arbitrary frame in order of time. In general, a second histogram is generated based on the first video frame in order of time in a video that is a search target.

According to another embodiment, the second information generation unit 300 may select a base video frame according to an input of a user. In other words, the user may select a search base frame from a video which is a search target through a selection input means (not shown), and the second information generation unit 300 also generates a second histogram on coding unit depth information of a frame subsequent to the selected base frame in order of time.

According to an embodiment, the second information generation unit 300 may generate second histograms on all video frames from the first video frame of a video which is a search target to the last video frame. According to another embodiment, the second information generation unit 300 may start generating second histograms beginning with the first video frame and generate second histograms only until a video frame corresponding to a key video frame which is a search objective is detected.

Meanwhile, when generating histogram information from one video frame, the second information generation unit 300 generates coding unit depth information of each of all LCUs constituting the corresponding video frame, and generates a histogram based on the coding unit depth information. A detailed method for the second information generation unit 300 to generate a histogram is the same as a method for the first information generation unit 200 to generate a histogram, and the detailed description thereof will be omitted.

The difference information generation unit 400 generates difference information between the first histogram and the second histogram, that is, coding unit depth histogram difference (CUDHD), using Equation 1 below.

$$CUDHD = {\sum }_{i} \vert {CUDHD}_{key} - {CUDHD}_{currentframe} \vert \qquad [ Equation 1 ]$$

(CUDHD_{key} is a histogram on coding unit depth information of a key frame which is a search objective, CUDHD_{currentframe} is a histogram on coding unit depth information of a frame which is a comparison target of the key frame, and i is an index representing depth information and used as an index to a depth of 0, 1, 2, or 3)

The image detection unit 500 detects the frame corresponding to the key frame based on the difference information.

According to an embodiment, the image detection unit 500 compares the difference information generated by the difference information generation unit 400 with a previously set threshold, and detects a frame which is a current comparison target as the frame corresponding to the key frame when a comparison result indicates that the difference information is smaller than the threshold.

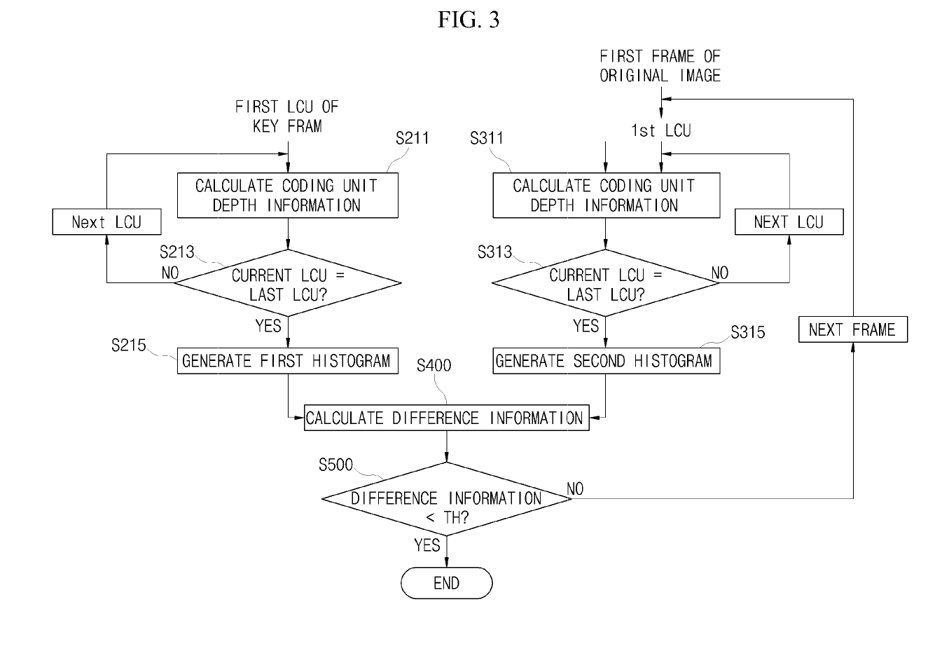

A method of processing an image according to another embodiment of the present invention will be described in detail below with reference to FIG. 3. FIG. 3 is a flowchart illustrating a method of searching for an image according to an embodiment of the present invention.

As illustrated in FIG. 3, the first information generation unit 200 and the second information generation unit 300 generate a first histogram and a second histogram.

The first information generation unit 200 calculates coding unit depth information regarding the first LCU of a key frame which is a search objective (S211). As described above, a coding unit depth represents image complexity and the degree of movement in the corresponding LCU, and the greater the coding unit depth, the greater the complexity or the degree of movement of the corresponding LCU. The first information generation unit 200 calculates a maximum depth value of the first LCU as coding unit depth information.

Coding unit depth information is calculated from all LCUs of the key frame, and when an LCU whose coding unit depth is currently being calculated is the last LCU of the key frame, a coding unit depth calculation process is completed (S213).

Subsequently, the first information generation unit 200 generates a first histogram using coding unit depths calculated from all the LCUs of the key frame (S215).

Meanwhile, the second information generation unit 300 calculates coding unit depth information regarding the first LCU of the first frame of a video which is a search target (S311). Like in the first information generation unit 200, coding unit depth information is calculated from all LCUs, and when an LCU whose coding unit depth is currently being calculated is the last LCU of the first frame, a coding unit depth calculation process is completed (S313).

Subsequently, the second information generation unit 300 generates a second histogram using coding unit depths calculated from all the LCUs of the first frame (S315).

The difference information generation unit 400 generates difference information between the first histogram and the second histogram, that is, CUDHD, using Equation 1 above (S400).

The image detection unit 500 compares the difference information with a previously set threshold, and detects the frame which is a comparison target as a frame corresponding to the key frame based on a comparison result (S500).

Specifically, when the comparison result indicates that the difference information is smaller than the threshold, the image detection unit 500 detects the frame which is a current comparison target as a frame corresponding to the key frame, and when the comparison result indicates that the difference information is equal to or larger than the threshold, S311, S313, S315, and S400 operations described above are performed again for the second frame.

Meanwhile, the above-described method of searching for an image according to the present invention can be implemented as a computer-readable code in a computer-readable recording medium. The computer-readable recording medium includes all types of recording media in which data readable by a computer system is stored. Examples of the computer-readable recording medium may be a read only memory (ROM), a random access memory (RAM), a magnetic tape, a magnetic disk, a flash memory, and an optical data storage device. In addition, the computer-readable recording medium may be distributed in computer systems connected via a computer communication network so that computer-readable codes can be stored and executed in a distributed manner.

Preferred embodiments for exemplifying the technical spirit of the present invention have been described and shown above, but the present invention is not limited to the shown and described constitutions and effects. Those of ordinary skill in the art would appreciate that various changes and modifications of the present invention can be made without departing from the technical spirit. Therefore, it is to be understood that all suitable changes, modifications, and equivalents fall within the scope of the present invention.

1. A method of searching for an image using coding unit depth information generated by a high efficiency video coding (HEVC) encoder, the method comprising:
(a) generating a first histogram on coding unit depth information of a key frame which is a search objective;
(b) generating a second histogram on coding unit depth information of a first frame from a video which is a search target;
(c) generating difference information between the first histogram and the second histogram; and
(d) detecting the first frame as a frame corresponding to the key frame based on the difference information.

2. The method of claim 1, wherein the generating of the first and second histograms comprises generating the histograms using coding unit depth information extracted according to largest coding units (LCUs) in HEVC.

3. The method of claim 1, wherein the generating of the difference information comprises generating the difference information between the histograms using an equation below
$$CUDHD = {\sum }_{i} \vert {CUDHD}_{key} - {CUDHD}_{currentframe} \vert$$
(CUDHD_{key} is the histogram on the coding unit depth information of the key frame which is the search objective, CUDHD_{currentframe} is the histogram on the coding unit depth information of the frame which is a comparison target of the key frame, and i is an index representing depth information).

4. The method of claim 1, wherein the detecting of the first frame comprises extracting the first frame as a frame to be searched for when the difference information is smaller than a previously set threshold.

5. The method of claim 1, further comprising, when a result of the detecting of the first frame indicates that the difference information is equal to or larger than a previously set threshold, performing (b) to (d) operations on a second frame which is a subsequent frame to the first frame.

6. An apparatus for searching for an image, the apparatus comprising:
a first information generation unit configured to generate a first histogram on coding unit depth information of a key frame which is a search objective;
a second information generation unit configured to generate a second histogram on coding unit depth information of a first frame from a video which is a search target;
a difference information generation unit configured to generate difference information between the first histogram and the second histogram; and
an image detection unit configured to detect a frame corresponding to the key frame based on the difference information.

7. The apparatus of claim 6, wherein the first and second information generation units generate the histograms using coding unit depth information extracted according to largest coding units (LCUs) in high efficiency video coding (HEVC).

8. The apparatus of claim 6, wherein the difference information generation unit generates the difference information between the histograms using an equation below
$$CUDHD = {\sum }_{i} \vert {CUDHD}_{key} - {CUDHD}_{currentframe} \vert$$
(CUDHD_{key} is the histogram on the coding unit depth information of the key frame which is the search objective, CUDHD_{currentframe} is the histogram on the coding unit depth information of the frame which is a comparison target of the key frame, and i is an index representing depth information).

9. The apparatus of claim 6, wherein the image detection unit extracts the first frame as a frame to be searched for when the difference information is smaller than a previously set threshold.

10. A computer-readable recording medium storing a program for causing a computer to execute the method of claim 1.

11. The apparatus of claim 6, wherein the first and second information generation units generate the histograms using coding unit depth information having a largest unit among pieces of coding unit depth information extracted according to largest coding units (LCUs) in high efficiency video coding (HEVC).

12. A computer-readable recording medium storing a program for causing a computer to execute the method of claim 2.

13. A computer-readable recording medium storing a program for causing a computer to execute the method of claim 3.

14. A computer-readable recording medium storing a program for causing a computer to execute the method of claim 4.

15. A computer-readable recording medium storing a program for causing a computer to execute the method of claim 5.
